(19) United States
(12) Patent Application Publication
(10) Pub. No.: US 2013/0291017 A1
(43) Pub. Date: Oct. 31, 2013

(54) IMAGE DISPLAY APPARATUS AND METHOD FOR OPERATING THE SAME

(71) Applicants: Sung O Cho, Gyeonggi-do (KR); Young Man Kim, Gyeonggi-do (KR)

(72) Inventors: Sung O Cho, Gyeonggi-do (KR); Young Man Kim, Gyeonggi-do (KR)

(73) Assignee: LG ELECTRONICS INC., Seoul (KR)

(21) Appl. No.: 13/877,610

(22) PCT Filed: Oct. 4, 2011
(86) PCT No.: PCT/KR11/07308

§ 371 Date: Jul. 15, 2013

(30) Foreign Application Priority Data
Oct. 4, 2010 (KR) 10-2010-0096433

(51) Int. Cl. H04N 21/482

(52) U.S. Cl. CPC H04N 21/482
USPC 725/45

(57) ABSTRACT

An image display apparatus and a method for operating the same are disclosed. The method for operating an image display apparatus includes receiving broadcast channel information, classifying channels into a 2D channel, a 3D channel or a mixed channel based on the received channel information, and displaying a channel list obtained by classifying the channels on a display if a channel list display command is input.

### TECHNICAL FIELD

The present invention relates to an image display apparatus and a method for operating the same, and more particularly to an image display apparatus, which is able to increase user convenience, and a method for operating the same.

### BACKGROUND ART

An image display apparatus functions to display images to a user. A user can view a broadcast program using an image display apparatus. The image display apparatus can display a broadcast program selected by the user on a display from among broadcast programs transmitted from broadcasting stations. The recent trend in broadcasting is a worldwide transition from analog broadcasting to digital broadcasting.

Digital broadcasting transmits digital audio and video signals. Digital broadcasting offers many advantages over analog broadcasting, such as robustness against noise, less data loss, ease of error correction, and the ability to provide clear, high-definition images. Digital broadcasting also allows interactive viewer services, compared to analog broadcasting.

### DISCLOSURE OF INVENTION

### Technical Problem

Therefore, the present invention has been made in view of the above problems, and it is an object of the present invention to provide an image display apparatus, which is able to increase user convenience, and a method for operating the same.

It is another object of the present invention to provide an image display apparatus, which is able to classify broadcast channels into a 2D channel, a 3D channel or a mixed channel so as to allow a user to easily recognize a broadcast channel, and a method for operating the same.

### Solution to Problem

In accordance with an aspect of the present invention, the above and other objects can be accomplished by the provision of a method for operating an image display apparatus, including receiving broadcast channel information, classifying channels into a 2D channel, a 3D channel or a mixed channel based on the received channel information, and displaying a channel list obtained by classifying the channels on a display if a channel list display command is input.

In accordance with another aspect of the present invention, there is provided a method for operating an image display apparatus, including displaying, on a display, a channel list obtained by classifying channels into a 2D channel, a 3D channel or a mixed channel based on received channel information, if a predetermined channel is selected from the channel list, displaying a broadcast image of the selected channel, and, if a command for moving the channel to a previous channel or a next channel is input, displaying a broadcast image of the previous channel or the next channel within channels of the same type as the selected channel.

In accordance with another aspect of the present invention, there is provided an image display apparatus including a display configured to display an image, a memory configured to store a channel list obtained by classifying channels into a 2D channel, a 3D channel or a mixed channel based on received channel information, and a controller configured to control the display to display the channel list if a channel list display command is input.

### Advantageous Effects of Invention

According to the embodiments of the present invention, by classifying broadcast channels into a 2D channel, a 3D channel or a mixed channel and displaying a channel list, a user can easily recognize a channel.

The user can view a desired channel based on the channel list. Therefore, it is possible to increase user convenience.

In case of a mixed channel, an object indicating that a displayed image is a 2D image or a 3D image is displayed. Therefore, it is possible to increase user convenience.

When a channel is moved within a channel list of a selected type, the user can continuously view only desired channels.

### BRIEF DESCRIPTION OF DRAWINGS

The above and other objects, features and other advantages of the present invention will be more clearly understood from the following detailed description taken in conjunction with the accompanying drawings, in which:

FIG. 1 is a block diagram showing an internal configuration of an image display apparatus according to an embodiment of the present invention;

FIG. 2 is block diagrams showing internal configurations of a set-top box and a display apparatus according to an embodiment of the present invention;

FIG. 3 is a block diagram showing an internal configuration of a controller of FIG. 1;

FIG. 4 is a diagram showing various formats of a 3D image;

FIG. 5 is a diagram showing an operation of a 3D viewing device according to the formats of FIG. 4;

FIG. 6 is a diagram showing various scaling schemes of a 3D image signal according to an embodiment of the present invention;

FIG. 7 is a diagram explaining an image formed by a left-eye image and a right-eye image;

FIG. 8 is a diagram explaining the depth of a 3D image according to a disparity between a left-eye image and a right-eye image;

FIG. 9 is a flowchart illustrating a method for operating an image display apparatus according to an embodiment of the present invention; and

FIGS. 10 to 36 are views referred to for describing various examples of the method for operating the image display apparatus, illustrated in FIG. 9.

### BEST MODE FOR CARRYING OUT THE INVENTION

Exemplary embodiments of the present invention will be described with reference to the attached drawings.

The terms “module” and “unit” attached to describe the names of components are used herein to help the understanding of the components and thus they should not be considered as having specific meanings or roles. Accordingly, the terms “module” and “unit” may be interchangeable in their use.

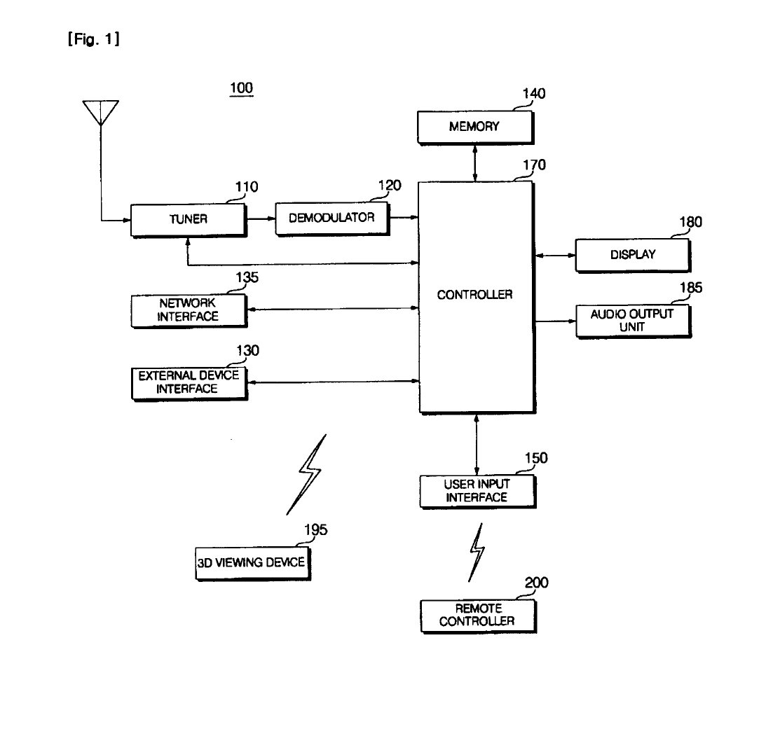

FIG. 1 a diagram showing the internal configuration of an image display apparatus according to an embodiment of the present invention.

Referring to FIG. 1, an image display apparatus 100 according to the embodiment of the present invention includes a tuner unit 110, a demodulator 120, an external device interface 130, a network interface 135, a memory 140, a user input interface 150, a sensor unit (not shown), a controller 170, a display 180, an audio output unit 185, and a 3D viewing device 195.

The tuner unit 110 tunes to a Radio Frequency (RF) broadcast signal corresponding to a channel selected by a user from among RF broadcast signals received through an antenna or RF broadcast signals corresponding to all channels previously stored in the image display apparatus. The tuned RF broadcast is converted into an Intermediate Frequency (IF) signal or a baseband Audio/Video (AV) signal.

For example, the tuned RF broadcast signal is converted into a digital IF signal DIF if it is a digital broadcast signal and is converted into an analog baseband AV signal (Composite Video Banking Sync/Sound Intermediate Frequency (CVBS/SIF)) if it is an analog broadcast signal. That is, the tuner unit 110 may process a digital broadcast signal or an analog broadcast signal. The analog baseband AV signal (CVBS/SIF) output from the tuner unit 110 may be directly input to the controller 170.

In addition, the tuner unit 110 may be capable of receiving RF broadcast signals from an Advanced Television Systems Committee (ATSC) single-carrier system or from a Digital Video Broadcasting (DVB) multi-carrier system.

The tuner unit 110 may sequentially select a number of RF broadcast signals corresponding to all broadcast channels previously stored in the image display apparatus by a channel storage function from a plurality of RF signals received through the antenna and may convert the selected RF broadcast signals into IF signals or baseband A/V signals.

The tuner unit 110 may include a plurality of tuners in order to receive broadcast signals of a plurality of channels. Alternatively, the tuner unit 110 may be a single tuner which simultaneously receives broadcast signals of a plurality of channels.

The demodulator 120 receives the digital IF signal DIF from the tuner unit 110 and demodulates the digital IF signal DIF.

For example, if the digital IF signal DIF output from the tuner unit 110 is an ATSC signal, the demodulator 120 may perform 8-Vestigal SideBand (VSB) demodulation. The demodulator 120 may also perform channel decoding. For channel decoding, the demodulator 120 may include a Trellis decoder, a de-interleaver and a Reed-Solomon decoder so as to perform Trellis decoding, de-interleaving and Reed-Solomon decoding.

For example, if the digital IF signal DIF output from the tuner unit 110 is a DVB signal, the demodulator 120 performs Coded Orthogonal Frequency Division Multiple Access (COFDMA) demodulation. The demodulator 120 may also perform channel decoding. For channel decoding, the demodulator 120 may include a convolution decoder, a de-interleaver), and a Reed-Solomon decoder so as to perform convolution decoding, de-interleaving, and Reed-Solomon decoding.

The demodulator 120 may perform demodulation and channel decoding, thereby obtaining a stream signal TS. The stream signal TS may be a signal in which a video signal, an audio signal and a data signal are multiplexed. For example, the stream signal TS may be an MPEG-2 Transport Stream (TS) in which an MPEG-2 video signal and a Dolby AC-3 audio signal are multiplexed. An MPEG-2 TS may include a 4-byte header and a 184-byte payload.

In order to properly handle not only ATSC signals but also DVB signals, the demodulator 120 may include an ATSC demodulator and a DVB demodulator.

The stream signal output from the demodulator 120 may be input to the controller 170 and thus subjected to demultiplexing and A/V signal processing. The processed video and audio signals are output to the display 180 and the audio output unit 185, respectively.

The external device interface 130 may serve as an interface between an external device 190 and the image display apparatus 100. For interfacing, the external device interface 130 may include an A/V Input/Output (I/O) unit (not shown) and/or a wireless communication module (not shown).

The external device interface 130 may be connected to an external device 190 such as a Digital Versatile Disk (DVD) player, a Blu-ray player, a game console, a camera, a camcorder, or a computer (e.g., a laptop computer), wirelessly or by wire. Then, the external device interface 130 externally receives video, audio, and/or data signals from the external device 190 and transmits the received input signals to the controller 170. In addition, the external device interface 130 may output video, audio, and data signals processed by the controller 170 to the external device. In order to receive or transmit audio, video and data signals from or to the external device, the external device interface 130 includes the A/V I/O unit (not shown) and/or the wireless communication module (not shown).

The A/V I/O unit may include a Universal Serial Bus (USB) port, a Composite Video Banking Sync (CVBS) port, a Component port, a Super-video (S-video) (analog) port, a Digital Visual Interface (DVI) port, a High-Definition Multimedia Interface (HDMI) port, a Red-Green-Blue (RGB) port, and a D-SUB port, in order to input the video and audio signals of the external device to the image display apparatus 100.

The wireless communication module may perform short-range wireless communication with other electronic devices. The image display apparatus 100 may be connected to the other electronic apparatuses over a network according to the communication protocols such as Bluetooth, Radio-Frequency IDentification (RFID), Infrared Data Association (IrDA), Ultra WideBand (UWB), ZigBee, and Digital Living Network Alliance (DLNA).

The external device interface 130 may be connected to various set-top boxes through at least one of the above-described ports and may thus receive data from or transmit data to the various set-top boxes.

The external device interface 130 may transmit or receive data to or from the 3D viewing device 195.

The network interface 135 serves as an interface between the image display apparatus 100 and a wired/wireless network such as the Internet. For connection to wireless networks, Wireless Local Area Network (WLAN) (i.e., Wi-Fi), Wireless Broadband (WiBro), World Interoperability for Microwave Access (WiMax), and High Speed Downlink Packet Access (HSDPA) may be used.

The network interface 135 may receive content or data provided by an Internet or content provider or a network operator over a network. That is, content such as movies, advertisements, games, VOD files, broadcast signals and information associated therewith may be received from the content provider over the network. Also, the network interface 135 may receive update information about firmware and update files of the firmware from the network operator. The network interface 135 may transmit data over the Internet or content provider or the network operator.

The network interface 135 may be connected to, for example, an Internet Protocol (IP) TV. The network interface 135 may receive and transmit video, audio or data signal processed by an IPTV set-top box to the controller 170, and transmit the signals processed by the controller 170 to the IPTV set-top box, for interactive communication.

The IPTV may include ADSL-TV, VDSL-TV, FTTH-TV, etc. according to the type of a transmission network and may include TV over DSL, Video over DSL, TV over IP (TVIP), Broadband TV (BTV), etc. The IPTV may include Internet TV and full-browsing TV.

The memory 140 may store various programs necessary for the controller 170 to process and control signals, and may also store processed video, audio and data signals.

The memory 140 may temporarily store a video, audio and/or data signal received from the external device interface 130. The memory 140 may store information about a predetermined broadcast channel by the channel storage function.

The memory 140 may include, for example, at least one of a flash memory-type storage medium, a hard disk-type storage medium, a multimedia card micro-type storage medium, a card-type memory (e.g. a Secure Digital (SD) or eXtreme Digital (XD) memory), a Random Access Memory (RAM), or a Read-Only Memory (ROM) such as an Electrically Erasable and Programmable Read Only Memory (EEPROM). The image display apparatus 100 may reproduce content stored in the memory 140 (e.g. video files, still image files, music files, text files, and application files) to the user.

While the memory 140 is shown in FIG. 1 as configured separately from the controller 170, to which the present invention is not limited, the memory 140 may be incorporated into the controller 170.

The user input interface 150 transmits a signal input by the user to the controller 170 or transmits a signal received from the controller 170 to the user.

For example, the user input interface 150 may receive various user input signals such as a power-on/off signal, a channel selection signal, and a screen setting signal from a remote controller 200 or may transmit a signal received from the controller 170 to the remote controller 200, according to various communication schemes, for example, RF communication and IR communication.

For example, the user input interface 150 may provide the controller 170 with user input signals received from local keys (not shown), such as inputs of a power key, a channel key, and a volume key, and setting values.

The sensor unit (not shown) may sense a user position, a user gesture or touch, or the position of the 3D viewing device 195. The sensor unit (not shown) may include a touch sensor, a voice sensor, a position sensor, a motion sensor, a gyro sensor, etc.

The user position, the user gesture or touch or the position of the 3D viewing device 195 sensed by the sensor unit may be input to the controller 170 directly or through the user input interface 150.

The controller 170 may demultiplex the stream signal TS received from the tuner unit 110, the demodulator 120, or the external device interface 130 into a number of signals, process the demultiplexed signals into audio and video data, and outputs the audio and video data.

The video signal processed by the controller 170 may be displayed as an image on the display 180. The video signal processed by the controller 170 may also be transmitted to an external output device through the external device interface 130.

The audio signal processed by the controller 170 may be output to the audio output unit 185. Also, the audio signal processed by the controller 170 may be transmitted to the external output device through the external device interface 130.

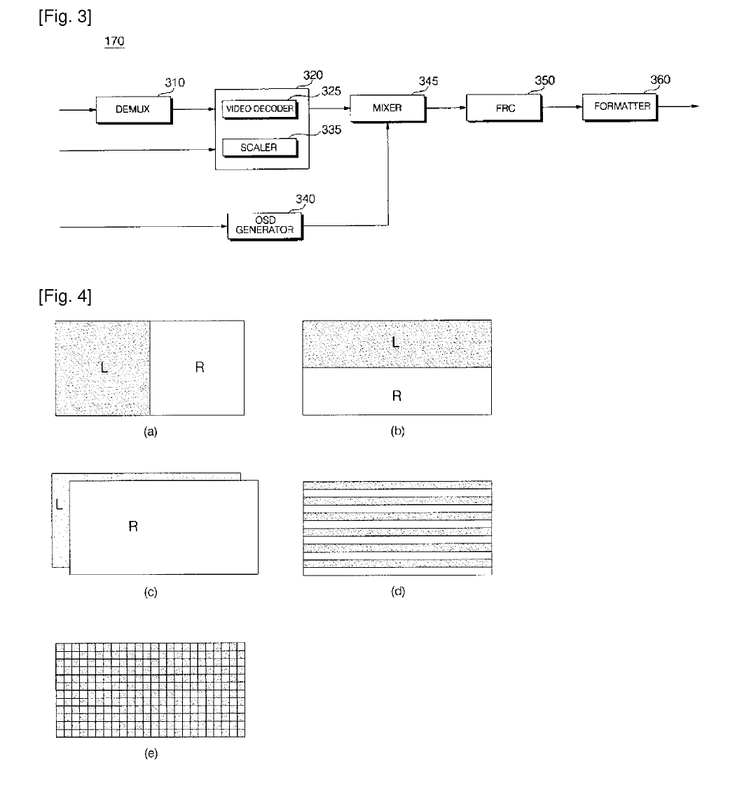

While not shown in FIG. 1, the controller 170 may include a DEMUX, a video processor, etc., which will be described in detail later with reference to FIG. 3.

The controller 170 may control the overall operation of the image display apparatus 100. For example, the controller 170 controls the tuner unit 110 to tune to an RF signal corresponding to a channel selected by the user or a previously stored channel.

The controller 170 may control the image display apparatus 100 by a user command or an internal program input through the user input interface 150.

For example, the controller 170 may control the tuner unit 110 to receive the signal of the selected channel according to a predetermined channel selection command received through the user input interface 150 and process the video, audio or data signal of the selected channel. The controller 170 outputs the channel information selected by the user along with the video or audio signal through the display 180 or the audio output unit 185.

As another example, the controller 170 outputs a video or audio signal received from the external device 190 such as a camera or a camcorder through the external device interface 130 to the display 180 or the audio output unit 185 according to an external device video playback command received through the external device interface 150.

The controller 170 may control the display 180 to display images. For instance, the controller 170 may control the display 180 to display a broadcast image received from the tuner unit 110, an external input image received through the external device interface 130, an image received through the network interface 135, or an image stored in the memory 140.

The image displayed on the display 180 may be a Two-Dimensional (2D) or Three-Dimensional (3D) still image or moving picture.

The controller 170 may generate and display a 3D object with respect to a predetermined object among images displayed on the display 180. For example, the object may be at least one of an accessed web screen (newspaper, magazine, etc.), an EPG, various menus, a widget, an icon, a still image, a moving image, or a text file.

The 3D object may be processed to have a depth different from an image displayed on the display 180. Preferably, the 3D object may be processed to appear to protrude from an image displayed on the display 180.

The controller 170 recognizes the position of the user based on an image captured by a camera unit (not shown). For example, a distance (z-axis coordinate) between the user and the image display apparatus 100 may be detected. An x-axis coordinate and a y-axis coordinate in the image display apparatus 100 corresponding to the position of the user may be detected.

The controller 170 may perform signal processing so as to allow the user to view an image using a display device.

For example, if the sensor unit (not shown) or the camera unit (not shown) detects whether the viewing device 195 is present or operated or the number of viewing devices, the controller 170 may perform signal processing to be paired with the viewing device 195. That is, the controller 170 may control the output of a pairing signal to the viewing device 195 and control the reception of a response signal from the viewing device 195.

The controller 170 may control the tuner unit 110 to receive a broadcast image according to the number of viewing devices 195. For example, if the number of viewing devices is 3, the controller 170 may control the tuner unit 110 including a plurality of tuners to receive broadcast images of different channels. The controller 170 may perform synchronization with the viewing devices such that the respective broadcast images are displayed at different times.

The controller 170 may receive external input images according to the number of viewing devices. For example, if the number of viewing devices is 3, the controller 170 may control reception of a broadcast image, an external input image from an optical device such as a DVD and an external input image from a PC. The controller 170 may perform synchronization with the viewing devices such that the respective images (the broadcast image, the DVD image and the PC image) are displayed at different times.

The controller 170 may increase the vertical synchronization frequency Vsync of a displayed image whenever the number of viewing devices is increased while displaying the image such that the respective images are displayed. For example, if a third viewing device is added in a state in which first and second images are synchronized with first and second 3D viewing devices so as to be displayed for 1/60 seconds, the controller 170 may respectively synchronize the first to third images with the first to third viewing devices for 1/60 seconds such that the first to third images are displayed. That is, by increasing the vertical synchronization frequency to 180 Hz in a state in which the first and second images are displayed with the vertical synchronization frequency of 120 Hz, the first to third images may be displayed.

The controller 170 may differently set a viewable image search object, for example, a channel search object of a broadcast image, according to viewing devices. For example, when searching for a channel, the channel search object may be differently set according to age groups such as an adult or a child. The channel search object may be differently set according to taste, sex, recent viewing channels or program rating.

When the same image is selected in the first viewing device and the second viewing device, the controller 170 may control transmission of a message indicating that the same image is selected. This message may be displayed on the display 180 in the form of an object or transmitted to the viewing devices as a RF signal.

Although not shown, a channel browsing processor for generating a thumbnail image corresponding to a channel signal or an external input signal may be further included. The channel browsing processor may receive the stream signal TS output from the demodulator 120 or the stream signal output from the external device interface 130, extract an image from the received stream signal, and generate a thumbnail image. The generated thumbnail image may be input to the controller 170 without conversion or in a state of being encoded. The generated thumbnail image may be encoded into a stream form to be input to the controller 170. The controller 170 may display a thumbnail list including a plurality of thumbnail images using the input thumbnail image. The thumbnail list may be displayed in a brief view method of displaying the thumbnail list in a part of an area in a state of displaying a predetermined image or may be displayed in a full viewing method of displaying the thumbnail list in a full area. The thumbnail images of the thumbnail list may be sequentially updated.

The display 180 converts the video signal, the data signal, the OSD signal and the control signal processed by the controller 170 or the video signal, the data signal and the control signal received by the external device interface 130 and generates a driving signal.

The display 180 may be a Plasma Display Panel (PDP), a Liquid Crystal Display (LCD), an Organic Light-Emitting Diode (OLED) display or a flexible display. In particular, the display 180 may be a 3D display. For viewing a 3D image, the display 180 may be divided into a supplementary display method and a single display method.

In the single display method, a 3D image is implemented on the display 180 without a separate subsidiary device, for example, glasses. The single display method may include, for example, a lenticular method, a parallax barrier, or the like.

In the supplementary display method, a 3D image is implemented on the display 180 using a subsidiary device. The supplementary display method includes various methods such as a Head-Mounted Display (HMD) method or a glasses method.

The glasses method may be divided into a passive method such as a polarized glasses method and an active method such as a shutter glasses method. The HMD method may be divided into a passive method and an active method.

The 3D viewing device 195 may be 3D glasses capable of viewing a 3D image. The 3D glasses 195 may include passive polarized glasses or active shutter glasses and may also include the above-described HMD method.

If the display 180 is a touch screen, the display 180 may function as not only an output signal but also an input device.

The audio output unit 185 receives the audio signal processed by the controller 170, for example, a stereo signal, a 3.1-channel signal or a 5.1-channel signal, and outputs the received audio signal as sound. The audio output unit 185 may be implemented by various types of speakers.

The camera unit (not shown) captures the user. Although the cameral unit (not shown) may include one camera, the present invention is not limited thereto and the camera unit may include a plurality of cameras. The camera unit (not shown) may be disposed on the display 180. The image information captured by the camera unit (not shown) is input to the controller 170.

The control unit 170 may sense the user gesture by the image captured by the camera unit (not shown), the signal sensed by the sensor unit (not shown), or a combination thereof.

The remote controller 200 transmits a user input to the user input interface 150. For transmission of user input, the remote controller 200 may use various communication techniques such as IR communication, RF communication, Bluetooth, Ultra Wideband (UWB) and ZigBee. In addition, the remote controller 200 may receive a video signal, an audio signal or a data signal from the user input interface 150 and output the received signals visually or audibly.

The above-described image display apparatus 100 may be a fixed digital broadcast receiver capable of receiving at least one of ATSC (8-VSB) broadcast programs, DVB-T (COFDM) broadcast programs, and ISDB-T (BST-OFDM) broadcast programs. The above-described image display apparatus 100 may be a mobile digital broadcast receiver capable of receiving at least one of terrestrial DMB broadcast programs, satellite DMB broadcast programs, ATSC-M/H broadcast programs, and media forward only broadcast programs. The image display apparatus 100 may be a cable, a satellite communication or IPTV digital broadcast receiver.

The image display apparatus described in the present specification may include a TV receiver, a mobile phone, a smart phone, a notebook computer, a digital broadcast terminal, a Personal Digital Assistant (PDA), a Portable Multimedia Player (PMP), etc.

The block diagram of the image display apparatus 100 illustrated in FIG. 1 is only exemplary. Depending upon the specifications of the image display apparatus 100 in actual implementation, the components of the image display apparatus 100 may be combined or omitted or new components may be added. That is, two or more components are incorporated into one component or one component may be configured as separate components, as needed. In addition, the function of each block is described for the purpose of describing the embodiment of the present invention and thus specific operations or devices should not be construed as limiting the scope and spirit of the present invention.

Unlike FIG. 1, the image display apparatus 100 may not include the tuner unit 110 and the demodulator 120 shown in FIG. 1 and may receive image content through the network interface 130 or the external device interface 135 and reproduce the image content.

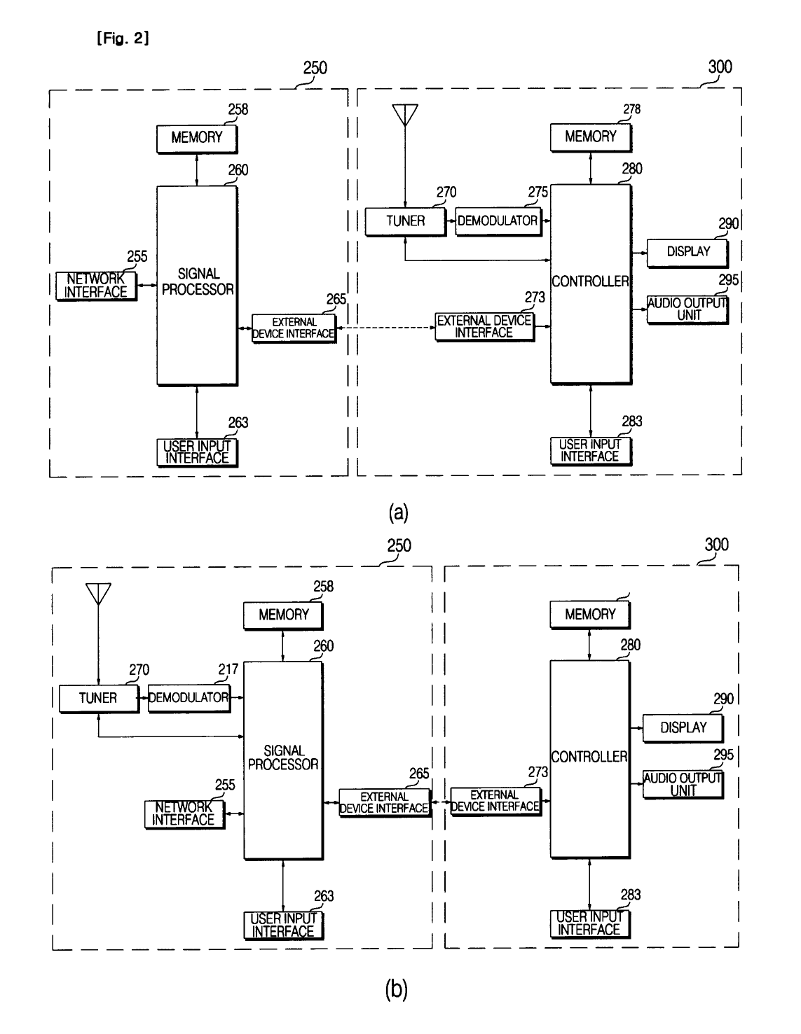

The image display apparatus 100 is an example of image signal processing apparatus that processes an image stored in the apparatus or an input image. Other examples of the image signal processing apparatus include a set-top box without the display 180 and the audio output unit 185, a DVD player, a Blu-ray player, a game console, and a computer. The set-top box will be described later with reference to FIG. 2.

FIG. 2 is block diagrams showing internal configurations of a set-top box and a display device according to an embodiment of the present invention.

Referring to FIG. 2(a), a set-top box 250 and a display device 300 may transmit or receive data wirelessly or by wire. Hereinafter, a difference between FIG. 2(a) and FIG. 1 will be focused upon.

The set-top box 250 may include a network interface 255, a memory 258, a signal processor 260, a user input interface 263, and an external device interface 265.

The network interface 255 serves as an interface between the set-top box 250 and a wired/wireless network such as the Internet. The network interface 255 may transmit data to or receive data from another user or another electronic device over a connected network or over another network linked to the connected network.

The memory 258 may store programs necessary for the signal processor 260 to process and control signals and temporarily store a video, audio and/or data signal received from the external device interface 265 or the network interface 255.

The signal processor 260 processes an input signal. For example, the signal processor 260 may demultiplex or decode an input video or audio signal. For signal processing, the signal processor 260 may include a video decoder or an audio decoder. The processed video or audio signal may be transmitted to the display device 300 through the external device interface 265.

The user input interface 263 transmits a signal received from the user to the signal processor 260 or a signal received from the signal processor 260 to the user. For example, the user input interface 263 may receive various control signals such as a power on/off signal, an operation input signal, and a setting input signal through a local key (not shown) or the remote controller 200 and output the control signals to the signal processor 260.

The external device interface 265 serves as an interface between the set-top box 250 and an external device that is connected wirelessly or by wire, particularly the display device 300, for signal transmission or reception. The external device interface 265 may also interface with an external device such as a game console, a camera, a camcorder, and a computer (e.g. a laptop computer), for data transmission or reception.

The set-top box 250 may further include a media input unit (not shown) for media playback. The media input unit may be a Blu-ray input unit (not shown), for example. That is, the set-top box 250 may include a Blu-ray player. After signal processing such as demultiplexing or decoding in the signal processor 260, a media signal from a Blu-ray disk may be transmitted to the display device 300 through the external device interface 265 so as to be displayed on the display device 300.

The display device 300 may include a tuner 270, an external device interface 273, a demodulator 275, a memory 278, a controller 280, a user input interface 283, a display 290, and an audio output unit 295.

The tuner 270, the demodulator 275, the memory 278, the controller 280, the user input interface 283, the display 290, and the audio output unit 295 are identical respectively to the tuner unit 110, the demodulator 120, the memory 140, the controller 170, the user input interface 150, the display 180, and the audio output unit 185 illustrated in FIG. 1 and thus a description thereof is not provided herein.

The external device interface 273 serves as an interface between the display device 300 and a wireless or wired external device, particularly the set-top box 250, for data transmission or reception.

Hence, a video signal or an audio signal received through the set-top box 250 is output through the display 290 or the audio output unit 295 under the control of the controller 280.

Referring to FIG. 2(b), the configuration of the set-top box 250 and the display device 300 illustrated in FIG. 2(b) is similar to that of the set-top box 250 and the display device 300 illustrated in FIG. 2(a), except that the tuner 270 and the demodulator 275 reside in the set-top box 250, not in the display device 300. Hereinafter, such difference will be focused upon.

The signal processor 260 may process a broadcast signal received through the tuner 270 and the demodulator 275. The user input interface 263 may receive a channel selection input, a channel store input, etc.

Although the audio output unit 185 of FIG. 1 is not shown in the set-top box 250 of FIGS. 2(a) and 2(b), a separate audio output unit may be included.

FIG. 3 is a block diagram showing the internal configuration of the controller illustrated in FIG. 1, FIG. 4 is a diagram showing various formats of a 3D image, and FIG. 5 is a diagram showing an operation of a 3D viewing device according to the formats of FIG. 4.

Referring to FIG. 3, the controller 170 according to the embodiment of the present invention may include a DEMUX 310, a video processor 320, an OSD generator 340, a mixer 345, a Frame Rate Converter (FRC) 350, and a formatter 360. The controller 170 may further include an audio processor (not shown) and a data processor (not shown).

The DEMUX 310 demultiplexes an input stream. For example, the DEMUX 310 may demultiplex an MPEG-2 TS into a video signal, an audio signal, and a data signal. The input stream signal may be received from the tuner unit 110, the demodulator 120 or the external device interface 135.

The video processor 320 may process the demultiplexed video signal. For video signal processing, the video processor 320 may include a video decoder 325 and a scaler 335.

The video decoder 325 decodes the demultiplexed video signal and the scaler 335 scales the resolution of the decoded video signal so that the video signal can be displayed on the display 180.

The video decoder 325 may be provided with decoders that operate based on various standards. The video decoder 325 may include at least one of an MPEG-2 decoder, a H.264 decoder, an MPEG-C decoder (MPEG-C part 3), an MVC decoder, and a FTV decoder.

The video signal decoded by the video processor 320 may include a 2D video signal, a mixture of a 2D video signal and a 3D video signal, or a 3D video signal.

For example, if an external video signal received from the external device 190 or a broadcast video signal received from the tuner unit 110 includes a 2D video signal, a mixture of a 2D video signal and a 3D video signal, or a 3D video signal. Thus, the controller 170 and, more particularly, the video processor 320 may perform signal processing and output a 2D video signal, a mixture of a 2D video signal and a 3D video signal, or a 3D video signal.

The decoded video signal from the video processor 320 may have any of various available formats. For example, the decoded video signal may be a 3D video signal with a color image and a depth image or a 3D video signal with multi-viewpoint image signals. The multi-viewpoint image signals may include, for example, a left-eye image signal and a right-eye image signal.

Formats of the 3D video signal may include a side-by-side format (FIG. 4(a)) in which the left-eye image L and the right-eye image R are arranged in a horizontal direction, a top/down format (FIG. 4(b)) in which the left-eye image and the right-eye image are arranged in a vertical direction, a frame sequential format (FIG. 4(c)) in which the left-eye image and the right-eye image are time-divisionally arranged, an interlaced format (FIG. 4(d)) in which the left-eye image and the right-eye image are mixed in line units, and a checker box format (FIG. 4(e)) in which the left-eye image and the right-eye image are mixed in box units.

The OSD generator 340 generates an OSD signal autonomously or according to a user input. For example, the OSD generator 340 may generate signals by which a variety of information is displayed as graphics or text on the display 180, according to user input signals. The OSD signal may include various data such as a User Interface (UI), a variety of menus, widgets, icons, etc. Also, the OSD signal may include a 2D object and/or a 3D object.

The mixer 345 may mix the decoded video signal processed by the video processor 320 with the OSD signal generated by the OSD generator 340. The OSD signal and the decoded video signal each may include at least one of a 2D signal or a 3D signal. The mixed video signal is provided to the FRC 350.

The FRC 350 may change the frame rate of the received video signal. For example, a frame rate of 60 Hz is converted into a frame rate of 120 Hz, 240 Hz or 480 Hz. When the frame rate is changed from 60 Hz to 120 Hz, the same first frame is inserted between a first frame and a second frame, or a third frame predicted from the first and second frames is inserted between the first and second frames. If the frame rate is changed from 60 Hz to 240 Hz, three identical frames or three predicted frames are inserted between the first and second frames. If the frame rate is changed from 60 Hz to 480 Hz, seven identical frames or seven predicted frames are inserted between the first and second frames.

The FRC 350 may output an input frame rate without frame rate conversion. Preferably, if a 2D video signal is input, the frame rate may remain unchanged. If a 3D video signal is input, the frame rate may be converted as described above.

The formatter 360 may arrange a left-eye video frame and a right-eye video frame of the 3D video signal subjected to frame rate conversion. The formatter 360 may output a synchronization signal Vsync for opening the left-eye glass and the right-eye glass of the 3D viewing device 195.

The formatter 360 may separate a 2D video signal and a 3D video signal from the mixed video signal of the OSD signal and the decoded video signal received from the mixer 345.

Herein, a 3D video signal refers to a signal including a 3D object such as a Picture-In-Picture (PIP) image (still or moving), an EPG that describes broadcast programs, a menu, a widget, text, an object within an image, a person, a background, or a Web page (e.g. from a newspaper, a magazine, etc.).

The formatter 360 may change the format of the 3D video signal, for example, to one of the various formats illustrated in FIG. 4. As shown in FIG. 5, an operation of a 3D viewing device of a glasses type may be performed according to the format.

FIG. 5(a) illustrates an exemplary operation of the 3D viewing device 195 and, more particularly, the shutter glasses 195 in the case where the formatter 360 outputs the frame sequential format illustrated in FIG. 4.

When the left-eye image L is displayed on the display 180, the left lens of the shutter glasses 195 is opened and the right lens is closed. When the right-eye image R is displayed on the display 180, the left lens of the shutter glasses 195 is closed and the right lens is opened.

FIG. 5(b) illustrates an exemplary operation of the 3D viewing device 195 and, more particularly, the polarized glasses 195 in the case where the formatter 360 outputs the side-by-side format illustrated in FIG. 4. The 3D viewing device 195 illustrated in FIG. 5(b) may be shutter glasses. The shutter glasses may operate like the polarized glasses by maintaining both the left-eye lens and the right-eye lens in an open state.

Meanwhile, the formatter 360 may convert a 2D video signal into a 3D video signal. For example, the formatter 360 may detect edges or a selectable object from the 2D video signal and generate a 3D video signal with an object based on the detected edges or the selectable object. As described before, the 3D video signal may be separated into left-eye and right-eye image signals L and R.

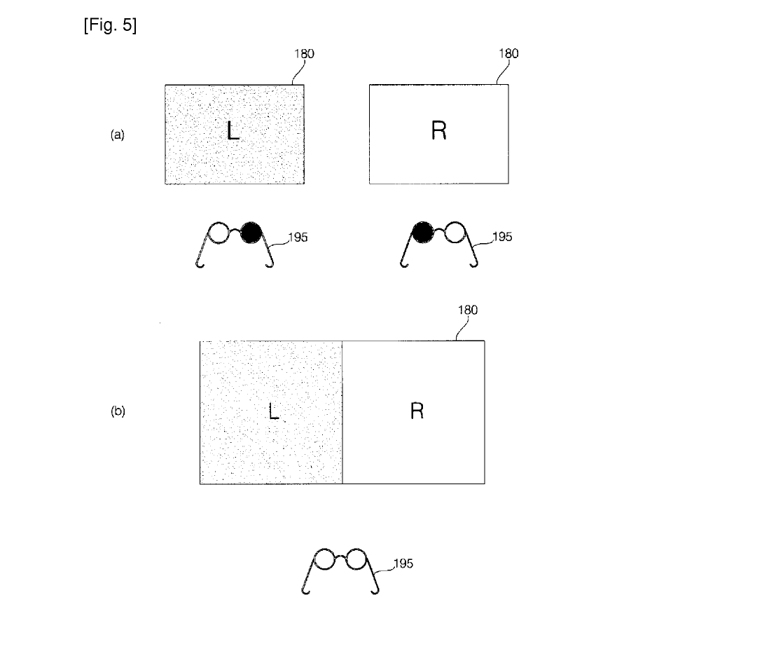

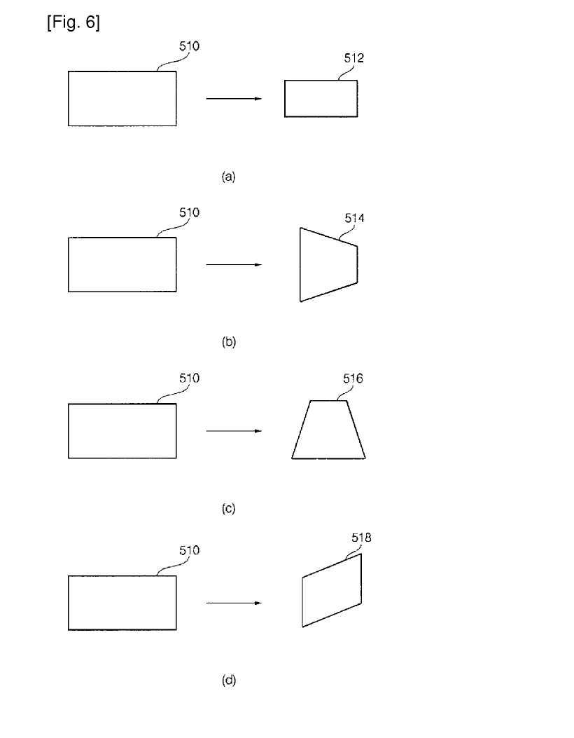

Although not shown, a 3D processor (not shown) for 3D effect signal processing may be further provided next to the formatter 360. The 3D processor may control brightness, tint, and color of the video signal, for 3D effect improvement. For example, a short-distance video signal may be clearly processed and a long-distance video signal may be blurredly processed. The function of the 3D processor may be incorporated into the formatter 30 or the video processor 320, which will be described later with reference to FIG. 6.

The audio processor (not shown) of the controller 170 may process the demultiplexed audio signal. For audio processing, the audio processor (not shown) may include various decoders.

For example, if the demultiplexed audio signal was coded, the audio processor may decode the audio signal. More specifically, if the demultiplexed audio signal is an MPEG-2 coded audio signal, an MPEG-2 decoder may decode the audio signal. If the demultiplexed audio signal was coded in compliance with MPEG 4 Bit Sliced Arithmetic Coding (BSAC) for terrestrial digital multimedia broadcasting (DMB), an MPEG 4 decoder may decode the audio signal. If the demultiplexed audio signal was coded in compliance with MPEG 2 Advanced Audio Codec (AAC) for satellite DMB or DVB-H, an AAC decoder may decode the audio signal. If the demultiplexed audio signal was coded in compliance with Dolby AC-3, an AC-3 decoder may decode the audio signal.

The audio processor (not shown) of the controller 170 may control bass, treble, and volume of the audio signal.

The data processor (not shown) of the controller 170 may process the demultiplexed data signal. For example, if the demultiplexed data signal was encoded, the data processor may decode the data signal. The encoded data signal may be Electronic Program Guide (EPG) information including broadcasting information such as the starts, ends, etc. of broadcast programs of each channel. For instance, the EPG information may be ATSC-Program and System Information Protocol (ATSC-PSIP) information in case of ATSC. In case of DVB, the EPG information may include DVB-Service Information (DVB-SI). The ATSC-PSIP information or DVB-SI may be included in the 4-byte header of the afore-described TS, i.e. the MPEG-2 TS.

Although the signals from the OSD generator 340 and the video processor 320 are mixed by the mixer 345 and then are subjected to 3D processing by the formatter 360 in FIG. 3, the present invention is not limited thereto and the mixer may be located at the next stage of the formatter. That is, the formatter 360 may perform 3D processing with respect to the output of the video processor 320, the OSD generator 340 may perform OSD generation and 3D processing, and then the mixer 345 may mix the processed 3D signals.

The block diagram of the controller 170 shown in FIG. 3 is exemplary. The components of the block diagrams may be integrated or omitted, or a new component may be added.

In particular, the FRC 350 and the formatter 360 may not be provided in the controller 170 and may be provided separately from the controller 170.

FIG. 6 is a diagram showing various scaling schemes of a 3D image signal according to an embodiment of the present invention.

Referring to FIG. 6, in order to increase the 3D effect, the controller 170 may perform 3D effect signal processing. In particular, the size or slope of a 3D object in a 3D image may be controlled.

A 3D video signal or a 3D object 510 of the 3D video signal may be enlarged or reduced to a predetermined ratio (512) as shown in FIG. 6(a) or the 3D object may be partially enlarged or reduced (trapezoids 514 and 516) as shown in FIGS. 6(b) and 6(c). As shown in FIG. 6(d), the 3D object may be at least partially rotated (parallelogram 518). By scaling (size control) or slope control, the 3D effect of the 3D image or the 3D object of the 3D image may be increased.

As the slope is increased, a difference between the lengths of both parallel sides of the trapezoids 514 and 516 may be increased as shown in FIG. 6(b) or 6(c) or a rotation angle is increased as shown in FIG. 6(d).

Size control or slope control may be performed after the 3D video signal is converted into a predetermined format by the formatter 360 or may be performed by the scaler of the video processor 320. In addition, the OSD generator 340 may generate an OSD signal so as to generate an object in shapes shown in FIG. 6, in order to increase the 3D effect.

Although not shown, as signal processing for the 3D effect, signal processing such as control of brightness, tint, and color of the video signal or the object may be performed in addition to size control or slope control shown in FIG. 6. For example, a short-distance video signal may be clearly processed and a long-distance video signal may be blurredly processed. Signal processing for the 3D effect may be performed by the controller 170 or a separate 3D processor. If signal processing for the 3D effect is performed by the controller 170, signal processing for the 3D effect may be performed by the formatter 360 or the video processor 320 along with size control or slope control.

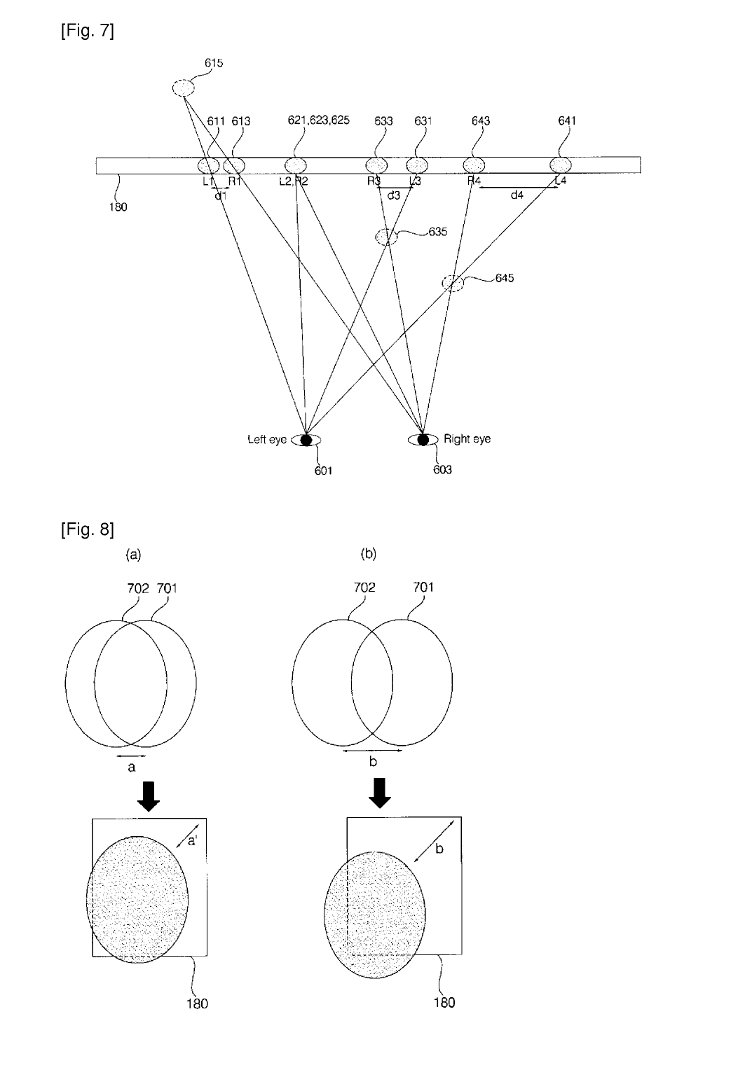

FIG. 7 is a diagram explaining an image formed by a left-eye image and a right-eye image, and FIG. 8 is a diagram explaining the depth of a 3D image according to a disparity between a left-eye image and a right-eye image.

First, referring to FIG. 7, a plurality of images or a plurality of objects 615, 625, 635 or 645 is shown.

A first object 615 includes a first left-eye image 611 (L) based on a first left-eye image signal and a first right-eye image 613 (R) based on a first right-eye image signal, and a disparity between the first left-eye image 611 (L) and the first right-eye image 613 (R) is d1 on the display 180. The user sees an image as formed at the intersection between a line connecting a left eye 601 to the first left-eye image 611 and a line connecting a right eye 603 to the first right-eye image 613. Therefore, the user perceives the first object 615 as being located behind the display 180.

Since a second object 625 includes a second left-eye image 621 (L) and a second right-eye image 623 (R), which are displayed on the display 180 to overlap, a disparity between the second left-eye image 621 and the second right-eye image 623 is 0. Thus, the user perceives the second object 625 as being on the display 180.

A third object 635 includes a third left-eye image 631 (L) and a third right-eye image 633 (R) and a fourth object 645 includes a fourth left-eye image 641 (L) with a fourth right-eye image 643 (R). A disparity between the third left-eye image 631 and the third right-eye images 633 is d3 and a disparity between the fourth left-eye image 641 and the fourth right-eye image 643 is d4.

The user perceives the third and fourth objects 635 and 645 at image-formed positions, that is, as being positioned before the display 180.

Because the disparity d4 between the fourth left-eye image 641 and the fourth right-eye image 643 is greater than the disparity d3 between the third left-eye image 631 and the third right-eye image 633, the fourth object 645 appears to be positioned closer to the viewer than the third object 635.

In embodiments of the present invention, the distances between the display 180 and the objects 615, 625, 635 and 645 are represented as depths. When an object is perceived as being positioned behind the display 180, the depth of the object is negative-signed. On the other hand, when an object is perceived as being positioned before the display 180, the depth of the object is positive-signed. Therefore, as an object appears closer to the user, the depth of the object is larger.

Referring to FIG. 8, if the disparity a between a left-eye image 701 and a right-eye image 702 in FIG. 8(a) is smaller than the disparity b between the left-eye image 701 and the right-eye image 702 in FIG. 8(b), the depth a′ of a 3D object created in FIG. 8(a) is smaller than the depth b′ of a 3D object created in FIG. 8(b).

In the case where a left-eye image and a right-eye image are combined into a 3D image, the positions of the images perceived by the user may changed by the disparity between the left-eye image and the right-eye image. This means that the depth of a 3D image or 3D object formed with a left-eye image and a right-eye image in combination may be controlled by adjusting the disparity between the left-eye and right-eye images.

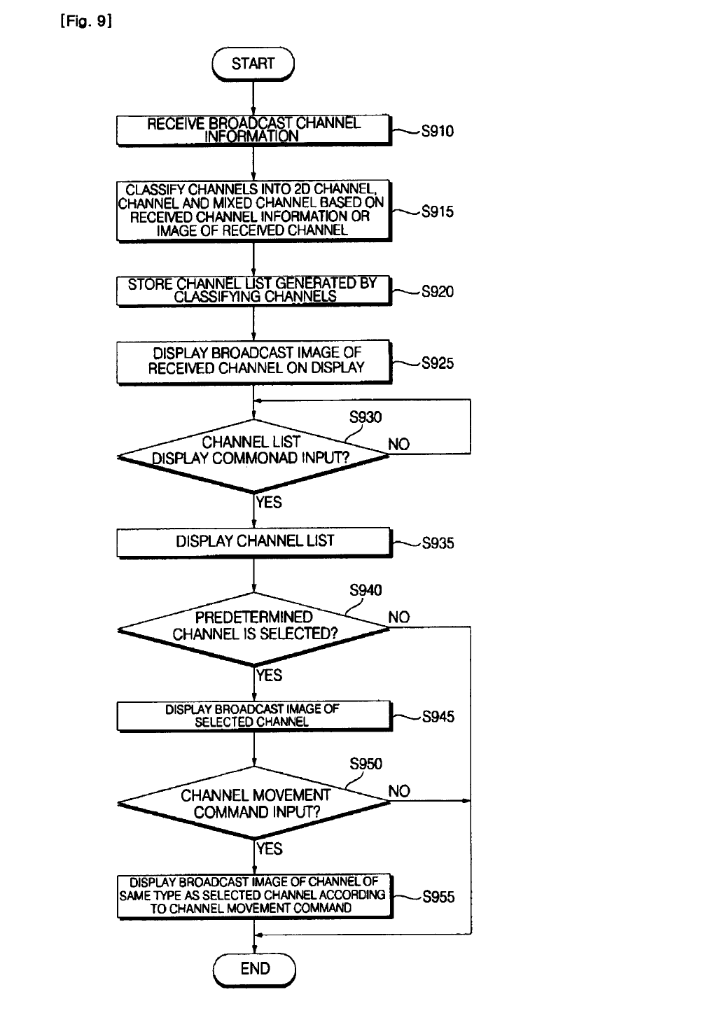

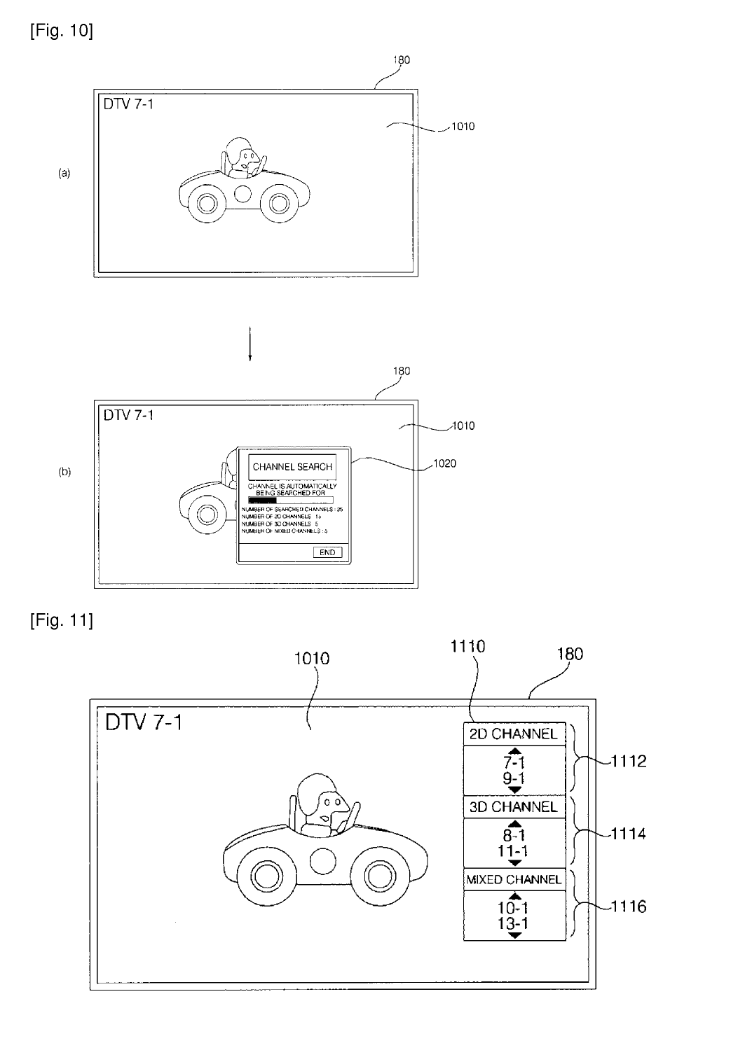

FIG. 9 is a flowchart illustrating a method for operating an image display apparatus according to an embodiment of the present invention, and FIGS. 10 to 36 are views referred to for describing various examples of the method for operating the image display apparatus, illustrated in FIG. 9.

Referring to FIG. 9, first, broadcast channel information is received (S910). Then, channels are classified into a 2D channel, a 3D channel or a mixed channel based on the received channel information (S915). Then, a channel list generated by classifying the channels is stored (S920).

The controller 170 receives a broadcast image or broadcast channel information input to the image display apparatus. A determination as to whether each channel is a 2D channel, a 3D channel or a mixed channel is made based on the received broadcast image or broadcast channel information.

For example, if a 3D image flag or 3D image format information is present in a header of the received video signal or if 3D image meta data is present, A determination as to whether each channel is a 2D channel, a 3D channel or a mixed channel may be made based on the 3D image flag, 3D image format information or 3D image meta data.

A “reserved” portion of an MPEG-2 video signal may be checked so as to determine whether the signal is a 3D image. For example, when a broadcast station transmits a video signal, as a 2-bit signal of the “reserved” portion, data “00” is transmitted in case of a 2D dedicated channel, data “10” is transmitted in case of a 3D dedicated channel and data “11” is transmitted in case of a mixture of 2D and 3D channels. The controller 170 of the image display apparatus 100 checks the 2-bit data of the “reserved” portion and classifies the channels into a 2D channel, a 3D channel or a mixed channel.

The controller 170 generates the channel list by classifying the channels. Although the channel list may include all the 2D channel, the 3D channel and the mixed channel, the channel list may be variously configured. For example, a 3D channel list may be separately generated or a 2D channel list may be separately generated.

The generated channel list may be stored in the memory 140.

Steps S910 to S920 may be performed upon automatic channel search. For example, when automatic channel search is performed, a determination as to whether each channel is a 2D channel, a 3D channel or a mixed channel may be made using channel information while channels are sequentially searched for, and the channel list may be generated by classifying the channels.

FIG. 10 shows an automatic channel search example. If automatic channel search is performed in a state in which a broadcast image 1010 is displayed on the display 180 as shown in FIG. 10(a), an automatic channel search progress screen 1020 may be displayed in a pop-up form in a state in which the broadcast image 1010 is displayed as shown in FIG. 10(b). In FIG. 10(b), the number of automatically searched channels 25, the number of 2D channels is 15, the number of 3D channels is 5 and the number of mixed channels is 5.

Before the generated channel list is stored in the memory 140, an object indicating whether or not a 2D channel list, a 3D channel list or a mixed channel list are distinguishably stored may be displayed on the display 180. Thus, the user may store only desired channel lists in the memory 140.

Next, the broadcast image of a received channel is displayed on the display (S925). Then, it is determined whether a channel list display command is input (S930). If it is determined that the channel list display command is input, the channel list generated by classifying the channels is displayed on the display (S935).

After channel search is completed, the controller 170 may control the display 180 to display the broadcast image 1010 shown in FIG. 10(a).

Thereafter, the controller 170 determines whether or not a channel list display command is input by manipulating a remote controller or a local key.

For example, if a channel list display command is input by pressing a specific key (a hot key, a color key, etc.) of the remote controller 200, the controller 170 controls the display 180 to display the channel list stored in the memory 140.

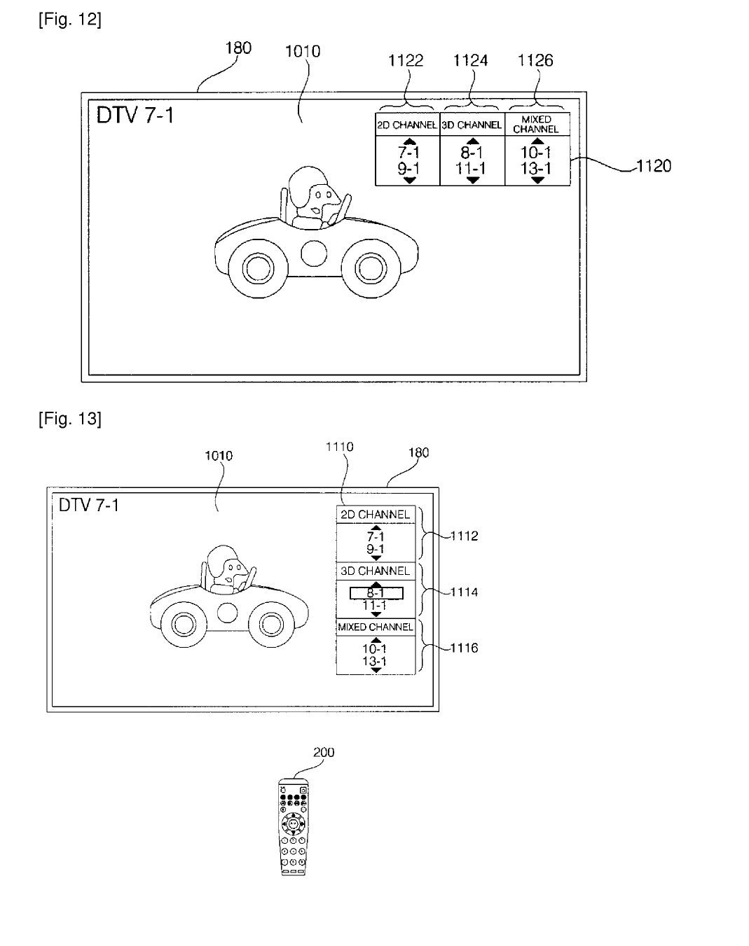

FIGS. 11 and 12 show various examples of channel list display.

First, FIG. 11 shows the case where a channel list 1110 is displayed in a portion of the display 180 in a state in which the broadcast image 1010 is displayed on the display 180. The channel list 1110 includes a 2D channel list 1112, a 3D channel list 1114 and a mixed channel list 1116, all of which are vertically arranged. In addition to the displayed channels, movement icons for additional channel display may be displayed as shown in FIG. 11.

Next, FIG. 12 shows the case where a channel list 1120 is displayed in a portion of the display 180 in a state in which the broadcast image 1010 is displayed on the display 180. The channel list 1120 includes a 2D channel list 1122, a 3D channel list 1124 and a mixed channel list 1126, all of which are horizontally arranged. In addition to the displayed channels, movement icons for additional channel display may be displayed as shown in FIG. 12.

Unlike FIGS. 11 and 12, when the channel list display command is input, a 2D channel list, a 3D channel list and a mixed channel list may be separately displayed or only any one thereof may be displayed. In particular, all or some of a 2D channel list, a 3D channel list and a mixed channel list may be displayed according to user setting.

By displaying the channel list, the user can easily recognize the channel. The user can view a desired channel based on the channel list. Accordingly, it is possible to increase user convenience.

Next, a determination as to whether a predetermined channel is selected (S940). If the predetermined channel is selected, the broadcast image of the selected channel is displayed (S945).

The controller 170 determines whether or not the channel is selected from the displayed channel list by manipulating the remote controller or the local key.

For example, if a cursor displayed on the display 180 is moved by manipulating a directional key of a remote controller, a channel may be selected. Alternatively, a channel may be selected by manipulating a numeric key of a remote controller. If a pointer is displayed on the display 180 according to movement of a remote controller, a channel may be selected according to movement of the pointer.

FIGS. 13 to 18 show various channel selection examples.

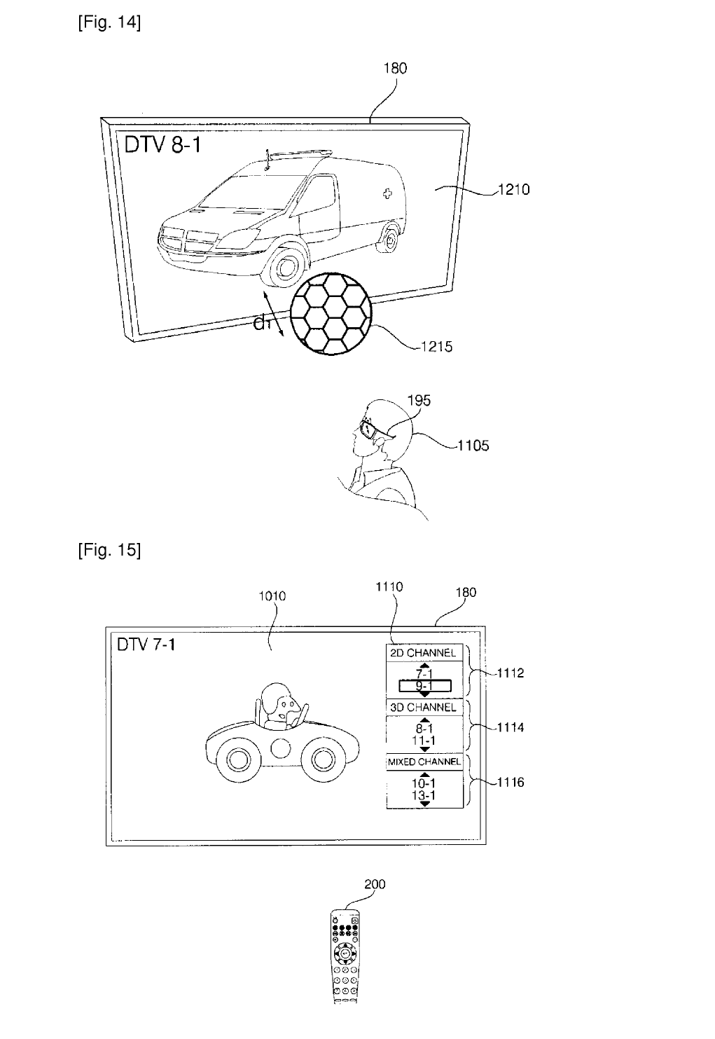

First, FIGS. 13 and 14 show a 2D channel selection example. FIG. 13 shows selection of an “8-1” channel among 3D channels using the remote controller 200 in a state in which a 2D broadcast image 1010 and a channel list 1110 are displayed on the display 180. Then, as shown in FIG. 14, a 3D broadcast image 1210 is displayed on the display 180. In particular, a user 1105 who wears the 3D viewing device 195 views a 3D object 1215 which appears to protrude by a predetermined depth d1.

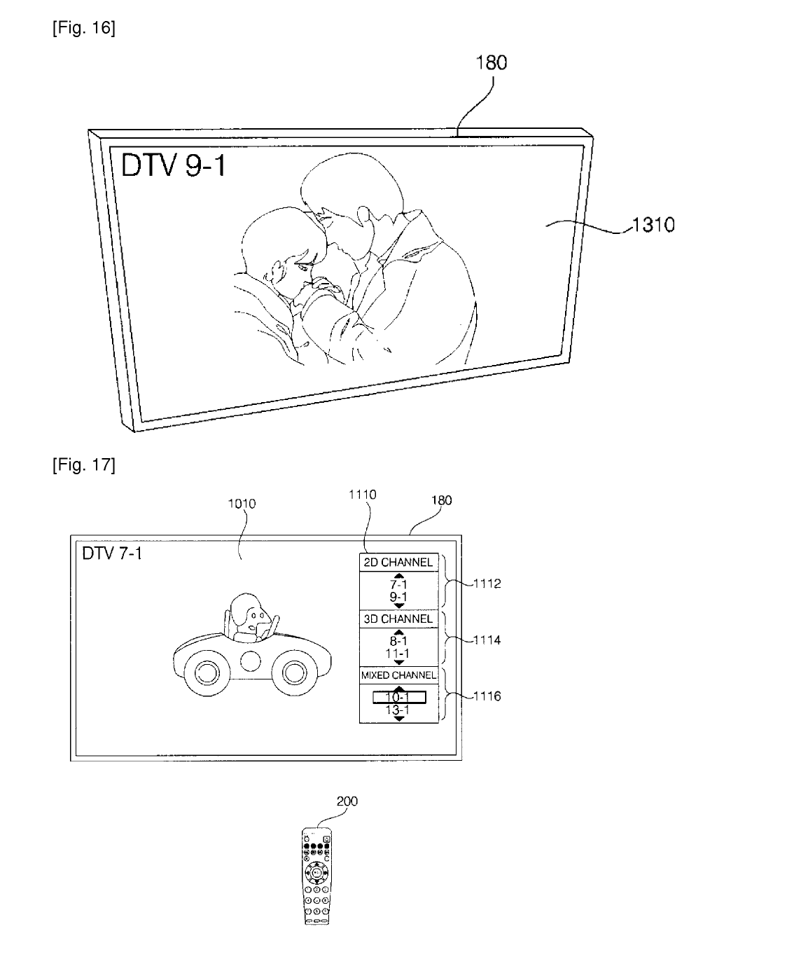

Next, FIGS. 15 and 16 show a 3D channel selection example. FIG. 15 shows selection of a “9-1” channel among 2D channels using the remote controller 200 in a state in which a 2D broadcast image 1010 and a channel list 1110 are displayed on the display 180. Then, as shown in FIG. 16, a 2D broadcast image 1310 is displayed on the display 180.

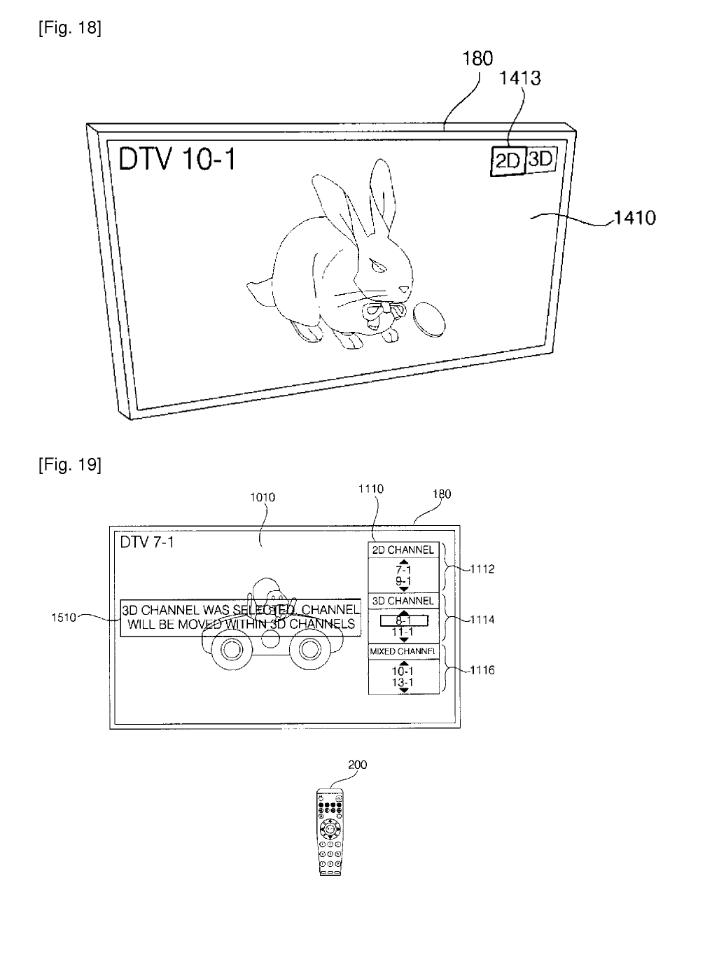

Next, FIGS. 17 and 18 show a mixed channel selection example. FIG. 17 shows selection of a “10-1” channel among mixed channels using the remote controller 200 in a state in which a 2D broadcast image 1010 and a channel list 1110 are displayed on the display 180. Then, as shown in FIG. 18, a 2D broadcast image 1410 is displayed on the display 180.

In the mixed channel, since a 2D broadcast image and a 3D broadcast image may be differently displayed according to time, an object indicating whether the displayed broadcast image is a 2D broadcast image or a 3D broadcast image may be displayed on the display 180. FIG. 18 shows an object 1413 indicating that the displayed broadcast image is a 2D image. Thus, the user can easily recognize that the displayed broadcast image is a 2D broadcast image or a 3D broadcast image.

Next, it is determined whether the channel is moved to a previous channel or a next channel (S950). If it is determined that the channel is moved, the channel is moved within the same type of channels and a broadcast image of a previous channel or a next channel is displayed (S955).

If selection of a predetermined channel from the channel list is completed, the controller 170 may control movement of the channel within the same type of channels when a channel movement command is input later. For example, if a command for moving the channel to a next channel is input while the broadcast image of a 3D channel selected from the channel list is displayed, the broadcast image corresponding to the channel next to the currently displayed 3D channel is controlled to be displayed.

For user convenience, if selection of a predetermined channel from the channel list is completed, an object indicating that the channel is moved within the selected channel type may be displayed on the display when the channel is moved later.

FIGS. 15, 22 and 25 show cases where such an object is displayed.

First, FIG. 19 shows the case where an object 1510 indicating that the channel is moved within the 3D channels when the channel is moved later is displayed on the display if an “8-1” channel of a 3D channel is selected from the channel list 1110.

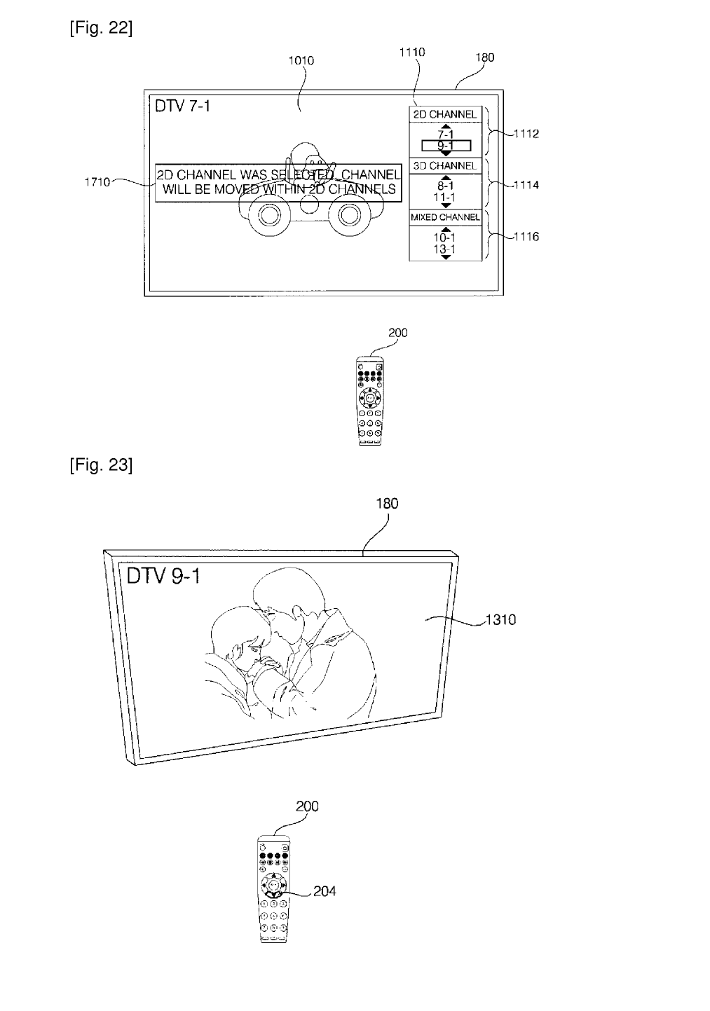

Next, FIG. 22 shows the case where an object 1710 indicating that the channel is moved within the 2D channels when the channel is moved later is displayed on the display, if a “9-1” channel of a 2D channel is selected from the channel list 1110.

Next, FIG. 25 shows the case where an object 1910 indicating that the channel is moved within the mixed channels when the channel is moved later is displayed on the display, if a “10-1” channel of a mixed channel is selected from the channel list 1110.

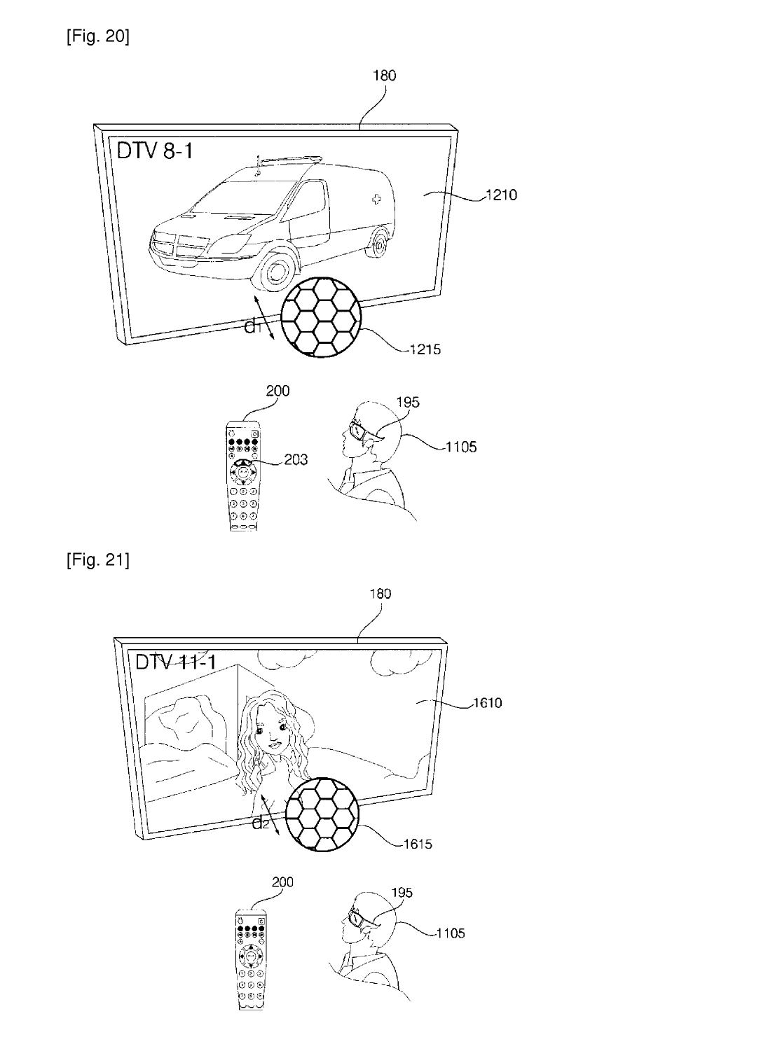

FIGS. 20, 21, 23, 24, 26 and 27 show various examples of channel movement.

First, FIG. 20 shows the case where a channel movement command is input using an up key 203 of the remote controller 200 in a state in which a 3D broadcast image 1210 of the “8-1” channel is displayed on the display 180. Then, as shown in FIG. 21, a 3D broadcast image 1610 of an “11-1” channel which is a next 3D channel of the “8-1” channel is displayed. In particular, a user 1105 who wears the 3D viewing device 195 views a 3D object 1215 which appears to protrude by a predetermined depth d1.

Accordingly, the user continues to view only a desired type of channels. Movement of the channel within the 3D channels may be separately performed by registering preferred channels and manipulating a hot key on a preferred channel list, in addition to the above-described operation for selecting the 3D channel.

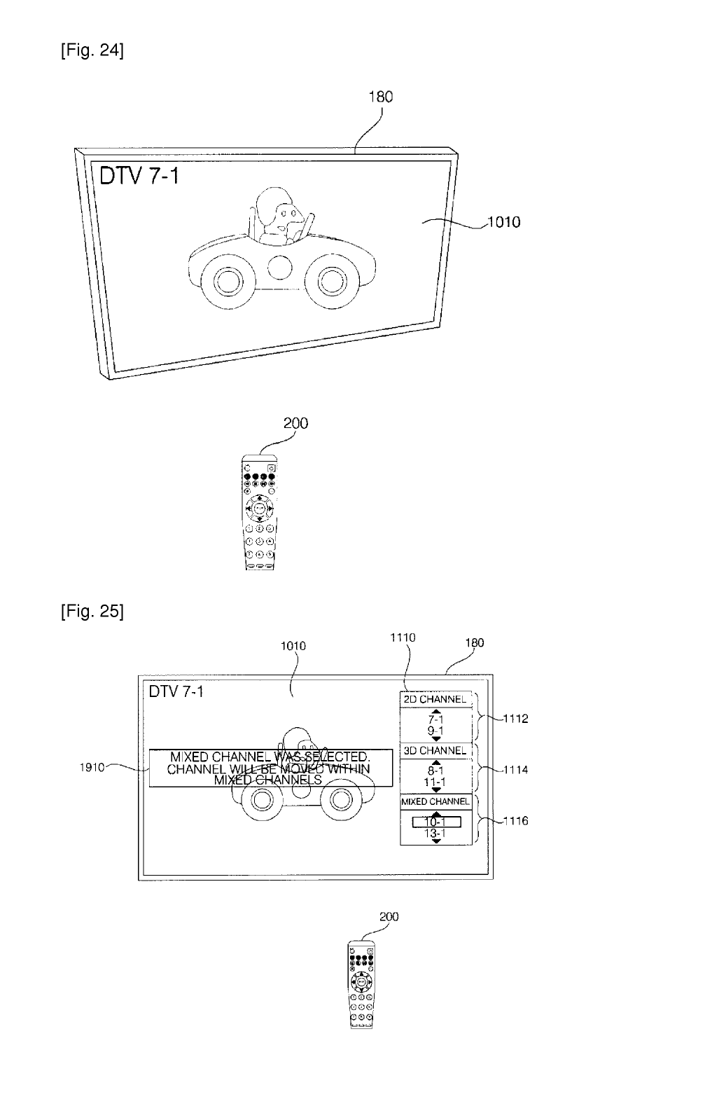

Next, FIG. 23 shows the case where a channel movement command is input using a down key 204 of the remote controller 200 in a state in which a 2D broadcast image 1310 of the “9-1” channel is displayed on the display 180. Then, as shown in FIG. 24, a 2D broadcast image 1010 of a “7-1” channel which is a previous 2D channel of the “9-1” channel is displayed.

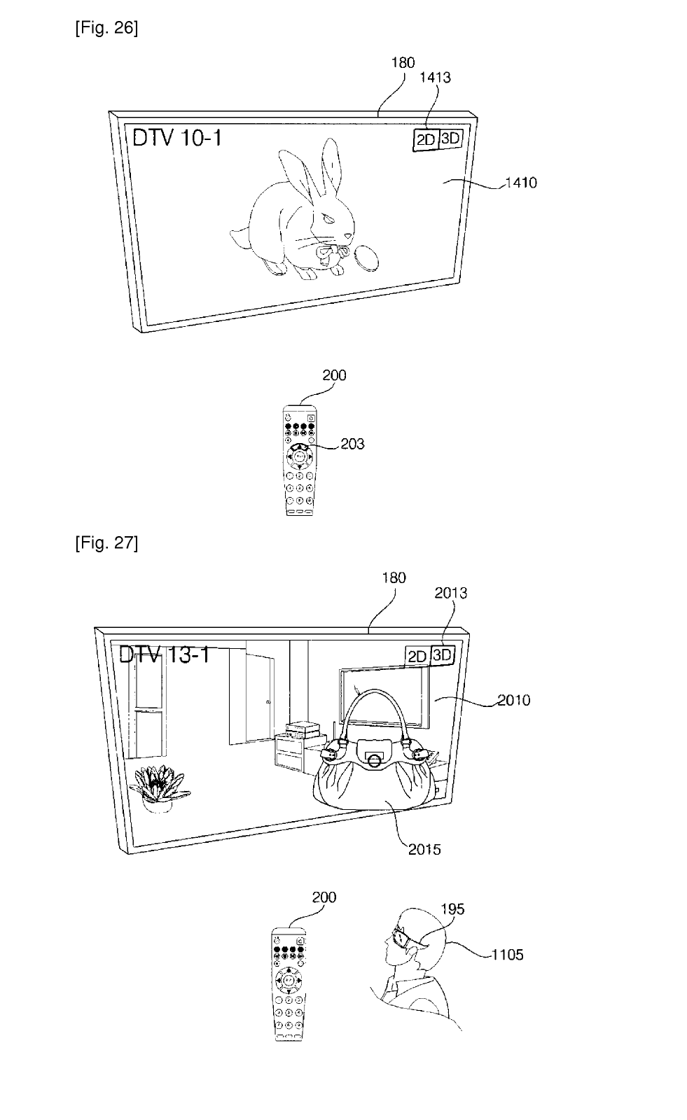

FIG. 26 shows the case where a channel movement command is input using the up key 203 of the remote controller 200 in a state in which a 2D broadcast image 1410 of the “10-1” channel is displayed on the display 180. Then, as shown in FIG. 27, a 3D broadcast image 2010 of a “13-1” channel which is a next mixed channel of the “10-1” channel is displayed. In particular, a user 1105 who wears the 3D viewing device 195 views a 3D object 2015 which appears to protrude by a predetermined depth.

In FIG. 26, since the “10-1” channel is a 2D channel before the channel is moved, an object 1413 indicating that the displayed image is a 2D image is displayed. In FIG. 27, since the “13-1” channel is a 3D channel after the channel is moved, an object 2013 indicating that the displayed image is a 3D image is displayed. Therefore, the user easily determines whether the broadcast image of the mixed channel is a 2D image or a 3D image.

If a channel movement command is input after the broadcast image of the selected channel is displayed, the channel may be moved to another type of channel.

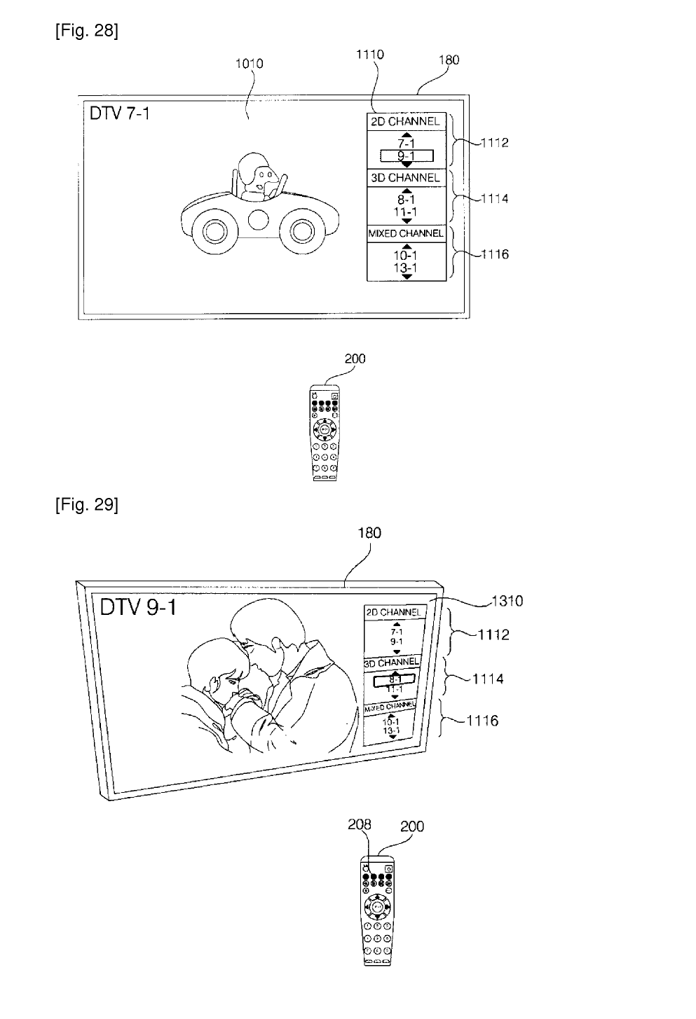

For example, if a 3D channel key is manipulated while a broadcast image of a 2D channel is viewed in a state in which a 2D channel key, a 3D channel key and a mixed channel are included in the remote controller 200, the channel may be immediately changed to a 3D channel, which will be described with reference to FIGS. 28 to 30.

FIG. 28 shows the case where a “9-1” channel is selected from among 2D channels using the remote controller 200 in a state in which a 2D broadcast image 1010 and a channel list 1110 are displayed on the display 180. Then, as shown in FIG. 29, a 2D broadcast image 1310 corresponding to the “9-1” channel is displayed on the display 180. At this time, the channel list 1110 may be continuously displayed.

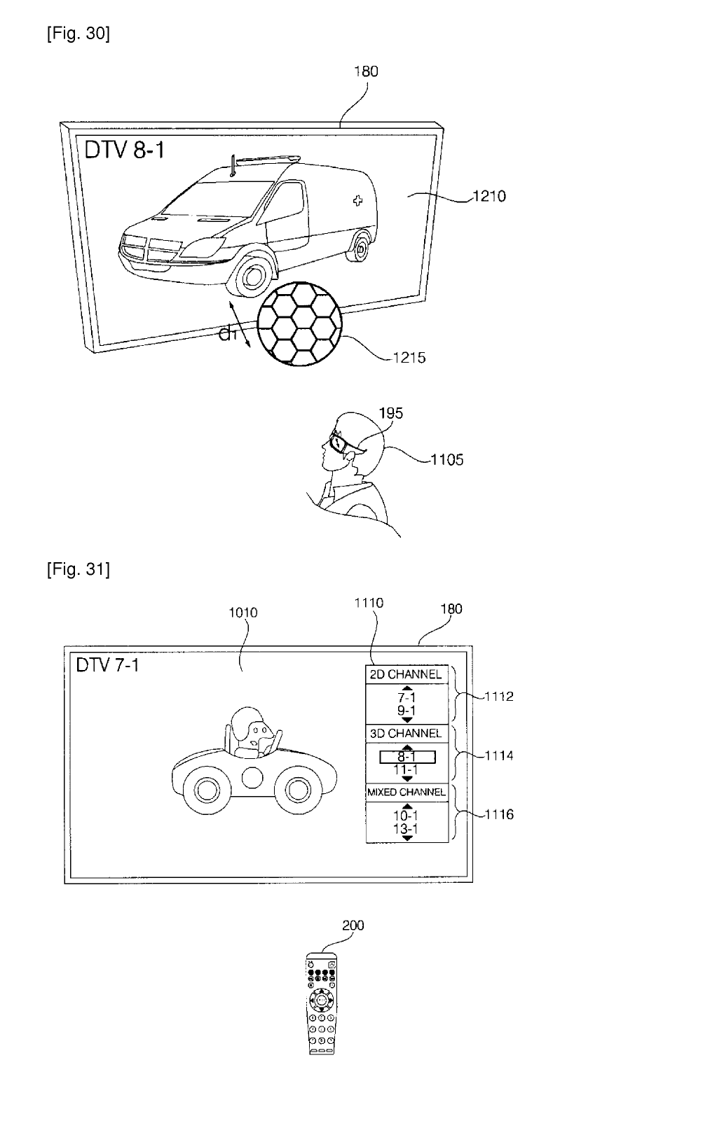

As shown in FIG. 29, if a 3D channel key 208 of the remote controller 200 is manipulated in a state in which the 2D broadcast image 1310 is displayed, the “8-1” channel of the 3D channel list 1114 of the channel list 1110 may be selected. Then, as shown in FIG. 30, a 3D broadcast image 1210 corresponding to the “8-1” channel is displayed on the display 180. Then, the channel can be easily moved to another type of channel.

The “8-1” channel of the 3D channel list 1114 may be selected as a default and may be, for example, a recently viewed 3D channel.

As another example, if a mixed channel key is manipulated while a broadcast image of a 2D channel is viewed in a state in which a 2D channel key, a 3D channel key and a mixed channel are included in the remote controller 200, the channel may be immediately changed to a mixed channel.

As another example, if a 2D channel key is manipulated while a broadcast image of a 3D channel is viewed in a state in which a 2D channel key, a 3D channel key and a mixed channel are included in the remote controller 200, the channel may be immediately changed to a 2D channel, which will be described with reference to FIGS. 31 to 33.

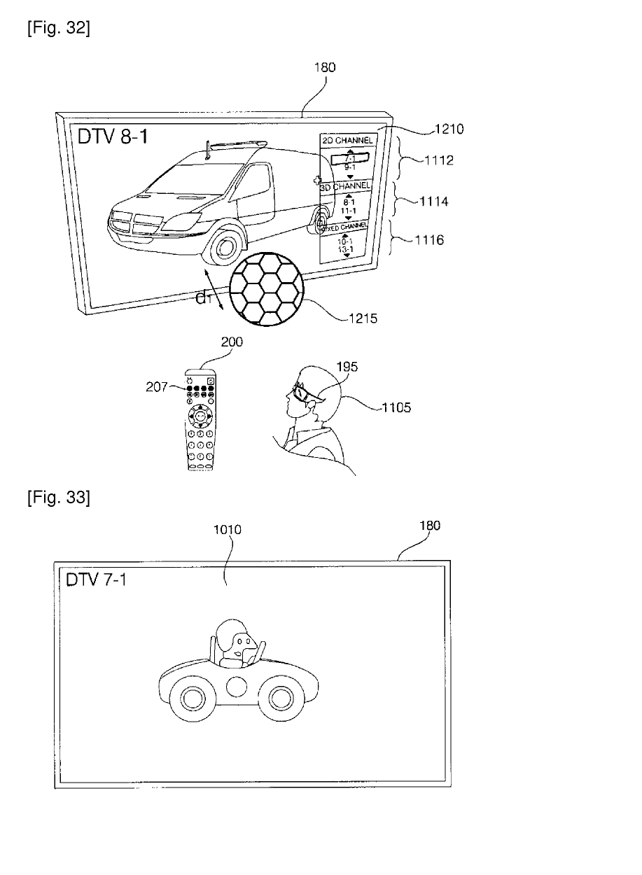

FIG. 31 shows the case where an “8-1” channel is selected from among 3D channels using the remote controller 200 in a state in which a 2D broadcast image 1010 and a channel list 1110 are displayed on the display 180. Then, as shown in FIG. 32, a 3D broadcast image 1210 corresponding to the “8-1” channel is displayed on the display 180. At this time, the channel list 1110 may be continuously displayed.

As shown in FIG. 32, if a 2D channel key 207 of the remote controller 200 is manipulated in a state in which the 3D broadcast image 1210 is displayed, the “7-1” channel of the 2D channel list 1112 of the channel list 1110 may be selected. Then, as shown in FIG. 33, a 2D broadcast image 1010 corresponding to the “7-1” channel is displayed on the display 180. Then, the channel can be easily moved to another type of channel.

The “7-1” channel of the 2D channel list 1112 may be selected as a default and may be, for example, a recently viewed 2D channel.

As another example, if a mixed channel key is manipulated while a broadcast image of a 3D channel is viewed in a state in which a 2D channel key, a 3D channel key and a mixed channel are included in the remote controller 200, the channel may be immediately changed to a mixed channel.

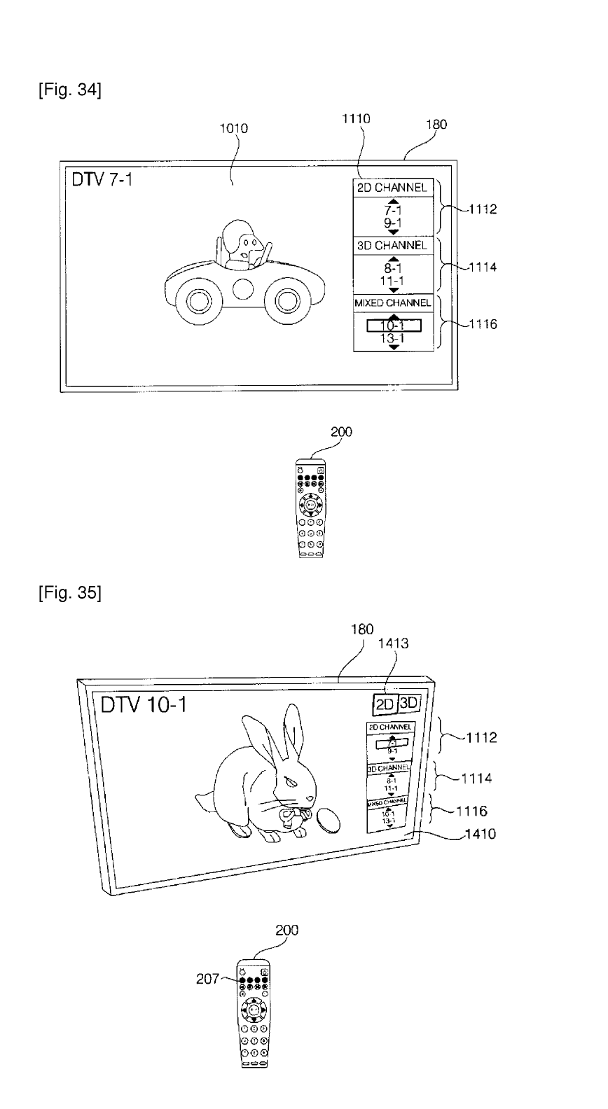

As another example, if a 2D channel key is manipulated while a broadcast image of a mixed channel is viewed in a state in which a 2D channel key, a 3D channel key and a mixed channel are included in the remote controller 200, the channel may be immediately changed to a 2D channel, which will be described with reference to FIGS. 34 to 36.

FIG. 34 shows the case where a “10-1” channel is selected from among mixed channels using the remote controller 200 in a state in which a 2D broadcast image 1010 and a channel list 1110 are displayed on the display 180. Then, as shown in FIG. 35, a 2D broadcast image 1410 corresponding to the “10-1” channel is displayed on the display 180. At this time, the channel list 1110 may be continuously displayed.

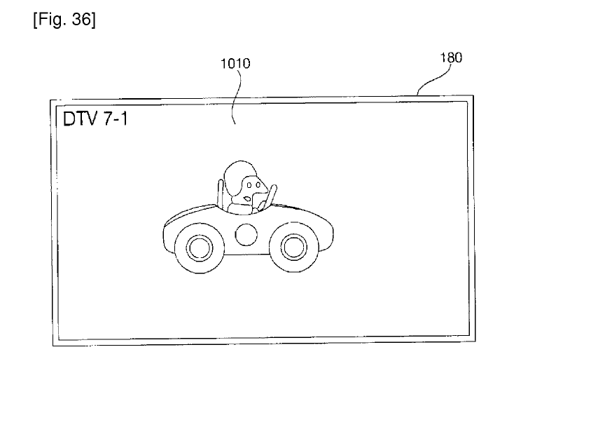

As shown in FIG. 35, if a 2D channel key 207 of the remote controller 200 is manipulated in a state in which the 2D broadcast image 1410 is displayed, the “7-1” channel of the 2D channel list 1112 of the channel list 1110 may be selected. Then, as shown in FIG. 36, a 2D broadcast image 1010 corresponding to the “7-1” channel is displayed on the display 180. Then, the channel can be easily moved to another type of channel.

The “7-1” channel of the 2D channel list 1112 may be selected as a default and may be, for example, a recently viewed 2D channel.

As another example, if a 3D channel key is manipulated while a broadcast image of a mixed channel is viewed in a state in which a 2D channel key, a 3D channel key and a mixed channel are included in the remote controller 200, the channel may be immediately changed to a 3D channel.

The image display apparatus and the method for operating the same according to the foregoing embodiments are not restricted to the embodiments set forth herein. Therefore, variations and combinations of the exemplary embodiments set forth herein may fall within the scope of the present invention.

The method for operating an image display apparatus according to the foregoing embodiments may be implemented as code that can be written to a computer-readable recording medium and can thus be read by a processor. The computer-readable recording medium may be any type of recording device in which data can be stored in a computer-readable manner. Examples of the computer-readable recording medium include a ROM, a RAM, a CD-ROM, a magnetic tape, a floppy disc, an optical data storage, and a carrier wave (e.g., data transmission over the Internet). The computer-readable recording medium can be distributed over a plurality of computer systems connected to a network so that computer-readable code is written thereto and executed therefrom in a decentralized manner. Functional programs, code, and code segments needed for realizing the embodiments herein can be construed by one of ordinary skill in the art.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

### INDUSTRIAL APPLICABILITY

The present invention is applied to an image display apparatus.

1. A method for operating an image display apparatus, comprising:
receiving broadcast channel information;
classifying channels into a 2D channel, a 3D channel or a mixed channel based on the received channel information; and
displaying a channel list obtained by classifying the channels on a display if a channel list display command is input.

2. The method according to claim 1, further comprising displaying a broadcast image of a received channel,
wherein the displaying of the channel list includes displaying the broadcast image on the display along with the channel list.

3. The method according to claim 1, further comprising, if a predetermined channel is selected from the channel list, displaying a broadcast image of the selected channel.

4. The method according to claim 3, further comprising displaying, if a channel movement command for moving the channel to a previous channel or a next channel is input after the predetermined channel is selected from the channel list, displaying a broadcast image of the previous channel or the next channel within channels of the same type as the selected channel.

5. The method according to claim 3, further comprising displaying an object indicating that the channel will be moved within a channel type, to which the selected channel belongs, after the predetermined channel is selected from the channel list.

6. The method according to claim 3, further comprising displaying an object indicating whether the displayed broadcast image is a 2D image or a 3D image, if the selected channel is a mixed channel.

7. The method according to claim 1, wherein the classifying of the channels is performed upon automatic channel search.

8. The method according to claim 1, wherein the channel list includes at least one of a 2D channel list, a 3D channel list or a mixed channel list.

9. The method according to claim 3, further comprising displaying a broadcast image of a channel of a type different from that of the selected channel, if a channel movement command for moving the channel to another type of channel is input after the predetermined channel is selected from the channel list.

10. A method for operating an image display apparatus, comprising:
displaying, on a display, a channel list obtained by classifying channels into a 2D channel, a 3D channel or a mixed channel based on received channel information;
if a predetermined channel is selected from the channel list, displaying a broadcast image of the selected channel; and
if a command for moving the channel to a previous channel or a next channel is input, displaying a broadcast image of the previous channel or the next channel within channels of the same type as the selected channel.

11. An image display apparatus comprising:
a display configured to display an image;
a memory configured to store a channel list obtained by classifying channels into a 2D channel, a 3D channel or a mixed channel based on received channel information; and
a controller configured to control the display to display the channel list if a channel list display command is input.

12. The image display apparatus according to claim 11, wherein the controller controls the display of a broadcast channel of a received channel along with the channel list.

13. The image display apparatus according to claim 11, wherein, if a predetermined channel is selected from the channel list, the controller controls the display of a broadcast image of the selected channel.

14. The image display apparatus according to claim 13, wherein, if a channel movement command for moving the channel to a previous channel or a next channel is input after the predetermined channel is selected from the channel list, the controller controls the display of a broadcast image of the previous channel or the next channel within channels of the same type as the selected channel.

15. The image display apparatus according to claim 13, wherein the controller controls the display of an object indicating that the channel will be moved within a channel type, to which the selected channel belongs, after the predetermined channel is selected from the channel list.

16. The image display apparatus according to claim 13, wherein the controller controls an object indicating whether the displayed broadcast image is a 2D image or a 3D image, if the selected channel is a mixed channel.

17. The image display apparatus according to claim 11, wherein the controller controls the classification of the channels if an automatic channel search command is input.

18. The image display apparatus according to claim 13, wherein, if a command for moving the channel to another type of channel is input after the predetermined channel is selected from the channel list, the controller controls the display of a broadcast image of a channel of a type different from that of the selected channel.
